(19) United States
(12) Patent Application Publication
(10) Pub. No.: US 2005/0156887 A1
(43) Pub. Date: Jul. 21, 2005

(54) Wireless mouse structure with illumination

(76) Inventor: Cliff Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/759,050

(22) Filed: Jan. 20, 2004

(51) Int. Cl. G09G 5/08

(52) U.S. Cl. 345/163

(57) ABSTRACT

A wireless mouse structure with illumination has a wireless mouse body and an illumination system. The wireless mouse body has an upper case, a lower case and a switch. The illumination system is disposed in the mouse body and has a plurality of light emitting devices and a battery. The battery is electrically connected to the plurality of light emitting devices, while the switch is electrically connected to both the plurality of light emitting devices and the battery. The illumination system is operable independently of an internal circuit of the mouse.

### BACKGROUND OF THE INVENTION

1. Field of the Invention

The present invention relates to a wireless mouse structure with illumination including a mouse body, and more particularly, to a wireless mouse structure having the functions of both an illumination system and a wireless mouse.

2. Description of the Related Art

A mouse, the specification of which ranges from the traditional RS-232 and PS/2 to today's wireless mouse, has become an indispensable peripheral for a computer. However, a mouse is typically designed to operate only as a mouse without any additional functions, which is quite monotonous. Some manufacturers have noticed the importance of a mouse to a computer, and have invested a lot of effort in improving the added value of a mouse.

Whenever the darkness comes, people always suffer from an unknown fear. Therefore scientists in the past had immersed themselves in the research of how to lighten the darkness, and thus illumination appliances were developed.

From torches to oil lamps and low-watt bulbs to fluorescent lamps, illumination appliances have become vital in human life. Even when camping in the outdoors, a flashlight is a “must have” for everyone.

The existence of mice and lamps is closely related to human's everyday life.

### SUMMARY OF THE INVENTION

To make a presentation, a lecturer usually prepares a portable computer and a wireless mouse for showing slides to the audience. When a power failure occurs or when something is missing in the dark room, it will be troublesome because the user has to find a substitute illumination appliance to look for the missing property. Provided that a mouse is combined together with an illumination system, the above development cost will be saved and the mouse will become more practical and convenient.

To achieve the above object, the inventor has developed a wireless mouse structure with illumination.

According to the present invention, an illumination system is provided in a wireless mouse body, and a switch is disposed on one side of the wireless mouse body to activate the operation of the illumination system Therefore, the mouse may either function as a wireless mouse or as an illumination device independently.

### BRIEF DESCRIPTION OF THE DRAWINGS

Features and advantages of the present invention will be fully understood from the detailed description to follow when taken in conjunction with the embodiments as illustrated in the accompanying drawings, which are to be considered in all respects as illustrative and not restrictive, in which:

FIG. 1 illustrates the external structure of the present invention;

FIG. 2 is a top view of the mouse according to the present invention;

FIG. 3 illustrates the internal structure of the present invention;

FIG. 4 shows the first embodiment according to the present invention;

FIG. 5 shows the second embodiment according to the present invention; and

FIG. 6 shows the third embodiment according to the present invention.

### DETAILED DESCRIPTION OF PREFERRED EMBODIMENTS

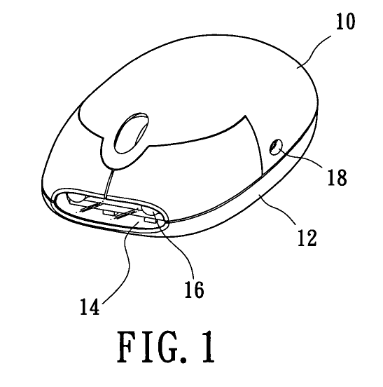

Referring to FIG. 1, which illustrates the external structure of a mouse according to the present invention, the mouse comprises an upper case 10 and a lower case 12 of a mouse body, a light guide plate 14, a plurality of light emitting devices 16 and a button 18.

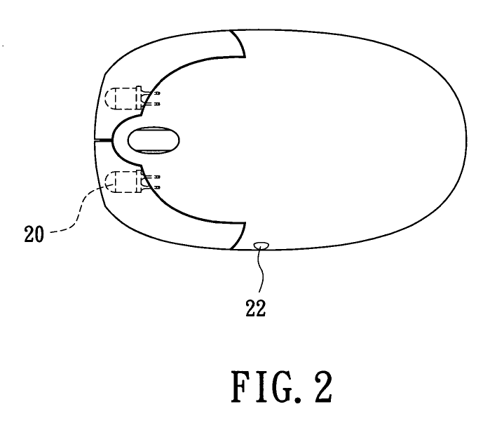

Referring to FIG. 2, which is a top view of a mouse according to the present invention, the mouse comprises a plurality of light emitting devices 20 and a button 22.

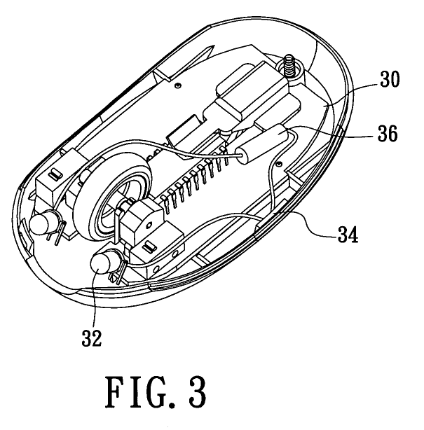

Referring now to FIG. 3, which illustrates the internal structure of a mouse according to the present invention, the mouse comprises a circuit structure in the mouse body 30, a plurality of light emitting devices 32, a switch 34 and a battery 36.

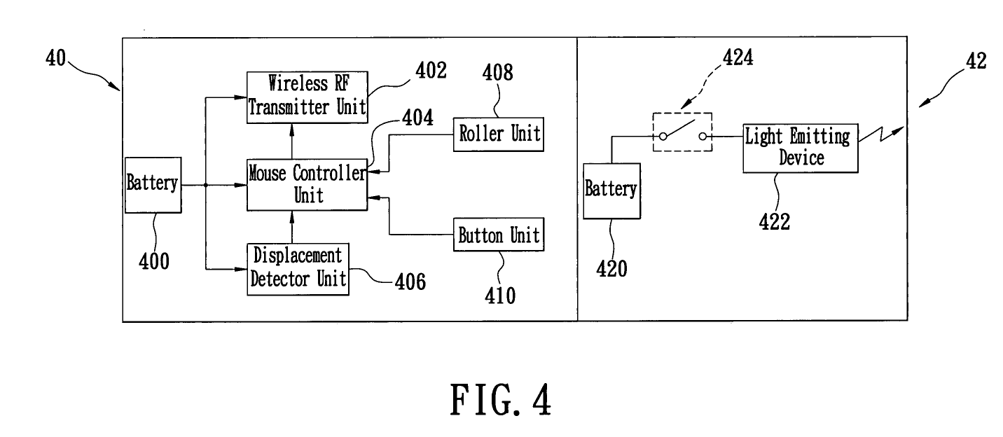

Referring to FIG. 4, the first embodiment of the present invention includes a circuit for a wireless mouse 40 and a circuit for an illumination system 42. The circuit for the wireless mouse 40 comprises a battery 400, a wireless RF transmitter unit 402, a mouse controller unit 404, a displacement detector unit 406, a roller unit 408 and a button unit 410. The circuit for the illumination system 42 comprises a battery 420, a mechanical switch 422 and light emitting devices 424.

The circuit for the wireless mouse and the circuit for the illumination system operate independently and are powered by separate batteries.

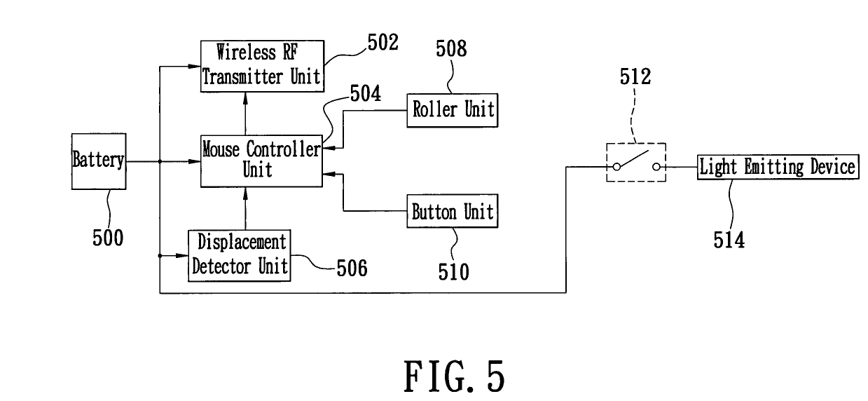

Referring to FIG. 5, the second embodiment of the present invention comprises a battery 500, a wireless RF transmitter unit 502, a mouse controller unit 504, a displacement detector unit 506, a roller unit 508, a button unit 510, a mechanical switch 512 and light emitting devices 514.

The major difference between the second embodiment and the first embodiment lies in that only one battery, instead of two separate batteries, is provided in the second embodiment. In other words, the circuit for the wireless mouse and the circuit for the illumination system are powered by the same battery.

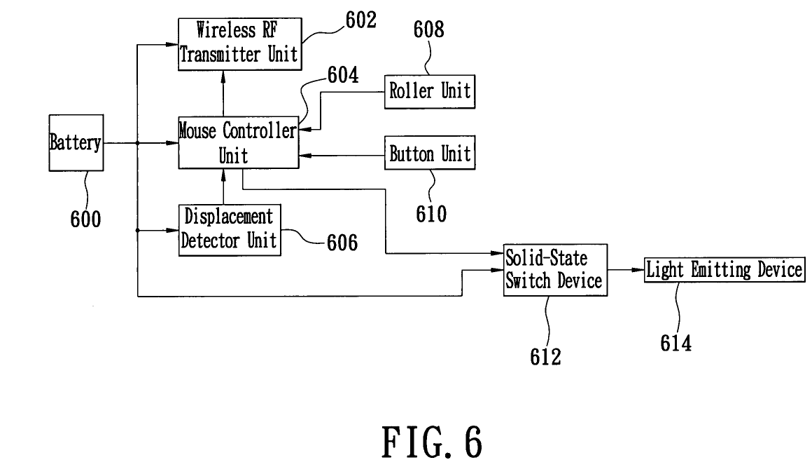

Referring to FIG. 6, the third embodiment of the present invention comprises a battery 600, a wireless RF transmitter unit 602, a mouse controller unit 604, a displacement detector unit 606, a roller unit 608, a button unit 610, a solid-state switch device 612 and light emitting devices 614.

The third embodiment is similar to the second embodiment with the exception of a solid-state switch device provided in place of the mechanical switch and operation of the solid-state switch device controlled by the mouse controller unit.

Ordinarily, the mouse according to the present invention may be used with any computer and functions like a typical wireless mouse.

In the darkness, the mouse of the invention may functions like a flashlight. When the switch provided on one side of the mouse is turned on, the circuit for the illumination system starts to operate. The circuit for the illumination system activated by the switch is electrically connected to the battery, and thus the light emitting devices can be powered by the battery to emit light, which is then radiated through the light guide plate. In the third embodiment, the circuit for the illumination system is activated by a specific button operation process.

According to the present invention, the circuit for the wireless mouse and the circuit for the illumination system are both disposed in a commonly shared housing of the wireless mouse, and therefore the unit cost of the present invention is lower when compared to the prior art where a mouse and a flashlight were designed separately. Further, thanks to the precise design of the internal circuit, each of the functions may operate independently.

With the above advantages, the invention is best implemented at a consumer product level and is acceptable and applicable by users.

The above disclosed technique of the invention provides novel designs, which is quite different from the prior art and improves the overall value of a mouse.

While the present invention has been described with reference to the detailed description and the drawings of the preferred embodiments thereof, it is to be understood that the invention should not be considered as limited thereby. Various modifications and changes could be conceived of by those skilled in the art without departuring from the scope of the present invention, which is indicated by the appended claims.

1. A wireless mouse structure with illumination, comprising:
a mouse body including an upper case and a lower case; and
an illumination system disposed in said mouse body;
wherein said illumination system is operable independently of an internal circuit of the mouse.

2. The wireless mouse structure with illumination of claim 1, wherein said illumination system further comprises:
a plurality of light emitting devices provided in said illumination system;
a battery set electrically connected to said plurality of light emitting devices; and
a switch electrically connected to said plurality of light emitting devices and said battery set.

3. The wireless mouse structure with illumination of claim 1, wherein said illumination system is independently operable of an internal circuit of the mouse.

4. The wireless mouse structure with illumination of claim 1, wherein said illumination system is associated with a control circuit of said mouse, whereby said illumination system is activated through a specific button operation process.

5. The wireless mouse structure with illumination of claim 1, wherein a plurality of holes is provided at one end of said mouse body.

6. The wireless mouse structure with illumination of claim 5, wherein said plurality of light emitting devices is disposed in said plurality of holes.

7. The wireless mouse structure with illumination of claim 6, wherein said plurality of light emitting devices is light emitting diodes.

8. The wireless mouse structure with illumination of claim 2, wherein said battery set is disposed in said mouse body, and said battery set is either a battery set exclusively for said mouse or a battery set shared with said wireless mouse.

9. The wireless mouse structure with illumination of claim 2, wherein said switch is disposed on one side of said mouse body.

10. The wireless mouse structure with illumination of claim 1, wherein said mouse body is further provided with a light guide plate at one end.
